(19) United States
(12) Patent Application Publication
(10) Pub. No.: US 2003/0105761 A1
(43) Pub. Date: Jun. 5, 2003

(54) Historic network configuration database

(76) Inventor: Mikael Lagerman, San Diego, CA (US)

Correspondence Address: COATS & BENNETT, PLLC, P O BOX 5, RALEIGH, NC, 27602, US

(21) Appl. No.: 09/990,148

(22) Filed: Nov. 21, 2001

(51) Int. Cl. G06F 7/00

(52) U.S. Cl. 707/10

(57) ABSTRACT

A method of managing network configuration data in a database includes storing current configuration data representing a current configuration of the network in a database as a collection of managed objects. Historical configuration data representing past configurations of the network is stored in the database as a collection of changed objects. Change parameters associated with the changes to the configuration data may additionally be stored. The database may be restored to a prior version, representing a prior configuration of the network, by restoring at least one changed object. The database may be altered to other configurations by restoring one or more changed objects. The changed objects to be restored may be selected by change parameters, such as a timestamp, operator identification, or group code. Proposed changes to the network may be modeled by substituting proposed configuration data for the current configuration data in the database.

### BACKGROUND OF THE INVENTION

The present invention relates generally to the field of communications network maintenance and specifically to a flexible, efficient method of tracking network database changes and restoring a network to a prior version.

A wireless communication network comprises a large number of components and systems, referred to herein as network elements, that need to be monitored and controlled by the systems operator. For management purposes, it is common to store variables needed to monitor and control the network elements in a database, referred to in the industry as a management information base (MIB). A MIB is a database that stores information about the configuration of a network element. In a MIB, the various components and systems within the wireless communication network are represented by a network model that comprises a collection of managed objects. A managed object is an abstract representation of a logical or physical resource that needs to be monitored and controlled by the system operator. A managed object is defined in terms of its attributes, operations that can be performed on the managed object, the notifications it can send, and its relationship to other managed objects. Examples of managed objects in a wireless communication network include a site, a cell or sector, a channel, a base station controller, a transceiver group, a transceiver, a transmitter, and a receiver. Each managed object has attributes that can be configured by the system operator. For example, attributes of a cell that can be configured by the system operator include its frequency and direction. For even a small network or a network element, the number of managed objects can be very large, consisting of thousands of managed objects.

Prudent network management dictates that the MIB be periodically saved so that a known operative configuration of the network can be restored in the event of the failure of one or more managed objects, or other network anomaly. As is known in the art, the practice of backing up and subsequently restoring the MIB can be simplified and made more efficient by performing only intermittent full backups (in which the complete set of configuration data is saved) and periodically saving incremental backups (the differences between current parameters and those stored in the last full backup).

Even using an optimized full/incremental backup and restore process, however, the traditional MIB is deficient in several respects. At each incremental backup, all changes to the MIB since the last full backup are stored together, and of course, the entire database is saved at each full backup. Thus, all temporally concurrent changes must be restored together in a recovery operation. However, some of the changes to the network may later be determined to have been problematic, and it is not desired to retain these changes, i.e., a version of the MIB prior to these changes being implemented is desired. Simultaneously, however, changes to other managed objects in the network may be determined to have been beneficial, and it is not desired to lose those changes. Additionally, a MIB typically contains a large amount of data, but relatively little data is changed at each iteration, thus traditional database backup and restore procedures are inefficient with respect to system resources such as backup media.

Another problem with current backup and restore procedures is the inability to record successive changes that occur between backups. If multiple changes are made to a managed object in the network between backups, only the last change will be recorded. Thus, information concerning the earlier changes will be lost.

### SUMMARY OF THE INVENTION

The present invention comprises a method of managing network configuration data in a database. Current configuration data representing a current configuration of the network is stored in a database as a collection of managed objects, where each managed object has attributes corresponding to variables that can be configured by the user to manage and control the operation of the network. A changed object is stored in the database for each managed object that changes. A changed object comprises historical configuration data representing a past configuration of the respective managed object prior to the change. Change parameters associated with the changes, such as the date/time of the change, may additionally be stored with the changed object. A past configuration of the network at any given time can be recreated by restoring one or more of the changed objects. Additionally, the present invention allows changes made in the past to be selectively rolled back to undo changes that were not beneficial and to keep changes that were beneficial. The changed objects to be restored may be selected by change parameters, such as a timestamp, operator identification, or group code. Proposed changes to the network may be modeled by substituting proposed configuration data for the current configuration data in the database.

### BRIEF DESCRIPTION OF DRAWINGS

FIG. 1 is a functional block diagram of a representative wireless communication network;

FIG. 2 is a diagram depicting a number of managed objects representing a current configuration of the network and associated changed objects representing past configurations of the network;

FIG. 3 is a diagram depicting a number of managed objects representing a current configuration of the network and associated changed objects representing both past and prospective configurations of the network;

FIG. 4 is a diagram illustrating the structure of a table used to store information about managed objects; and

FIGS. 5A through 5c are schematic diagrams illustrating various locations where the network configuration database may reside.

### DETAILED DESCRIPTION OF THE INVENTION

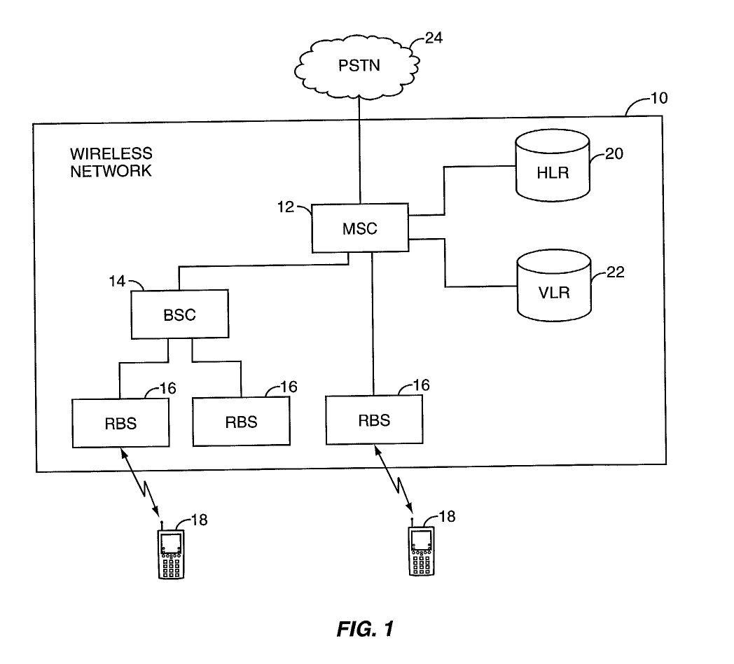

A typical wireless communication network 10 is depicted in FIG. 1. The network 10 contains a plurality of entities, such as a Mobile Switching Center (MSC) 12, a Base Station Controller (BSC) 14, Radio Base Stations (RBSs) 16, a Home Location Register (HLR) 20, and a Visitor Location Register (VLR) 22. RBSs 16 establish and maintain wireless voice and data communications links to mobile terminals 18, such as via radio frequency transmissions. One or more RBSs 16 may be controlled by a BSC 14, which routes communications between the RBSs 16, or between an RBS 16 and an MSC 12. MSC 12 may connect a mobile call between RBSs 16; between a RBS 16 and a RBS 16 connected to a different MSC 12 (not shown); or to another communications network, such as the Public Switched Telephone Network (PSTN) 24. The MSC 12 is connected to a HLR 20, a database containing information associated with subscribers within the area serviced by MSC 12. Additionally, MSC 12 is connected to VLR 22, a database used to store user information associated with visiting or (roaming) subscribers. Note that the wireless communication network 10 may contain other entities not shown in FIG. 1.

Information concerning the current configuration of the network is typically stored in a database generally referred to in the industry as a management information base (MIB). The MIB comprises a collection of managed objects that represent the physical and logical resources of the network or of a specific network element. Each managed object is defined by its attributes (i.e., variables), the operations that can be performed on the managed object, the notifications it can send, and its relationship to other managed objects. Managed objects, per se, are described in CCITT Rec. X.700 (“Management Framework for OSI”) and X.701 (“OSI—Systems Management Overview”), the contents of which are incorporated herein by reference in their entireties. The principles for naming and identifying managed objects are further described in CCITT Rec. X.720 (“Structure of Management Information. Part 1: Management Information Model”), the content of which is incorporated herein by reference in its entirety.

There is not necessarily a one-to-one correspondence between network resources and managed objects. Each resource within the network or network element being modeled may be represented by one or more managed objects. Similarly, a single managed object may represent a group of resources (e.g., a transceiver group). Examples of managed objects in a wireless communication system include a site, a cell or sector, a channel, a base station controller, a transceiver group, a transceiver, a transmitter, and a receiver.

Each managed object has attributes representing variables that can be configured and/or controlled by the system operator. For example, attributes of a cell that can be configured by the system operator include its frequency, direction, transmit power, and power control parameters. The relationship between a cell and its neighbor cell(s) may include attributes, such as a hand-off threshold, and thus the neighbor relationship may be represented as a managed object in the database. In general, the term “managed object” is used herein as defined in the CCITT standards.

The present invention relates to a novel method of maintaining a MIB. The present invention allows all historic configurations, or prior states, of the network to be easily regenerated, in a manner that provides increased efficiency and flexibility over prior art methods. The present invention allows rollback of selected managed objects to a previous state while other managed objects remain in their current state. This ability allows creation of new states that is not possible or is impractical with prior art database maintenance methods. Additionally, the present invention obviates the need to maintain backup copies of the MIB to recreate prior states (other than the backup used for disaster recovery, which prudent database maintenance would dictate for any important data).

According to the present invention, the MIB contains a collection of managed objects that represent the current configuration of the network or network element being modeled. Additionally, the MIB 30 stores changed versions of the managed objects, referred to herein as changed objects, which contain historical configuration data. A changed object represents the past configuration of a managed object that has been changed. More particularly, a changed object represents the configuration of the managed object as it existed just prior to the change. By storing historical configuration data as changed objects, it is possible to reconstruct or restore past configurations of the network at any given point in time, as will be described in more detail below.

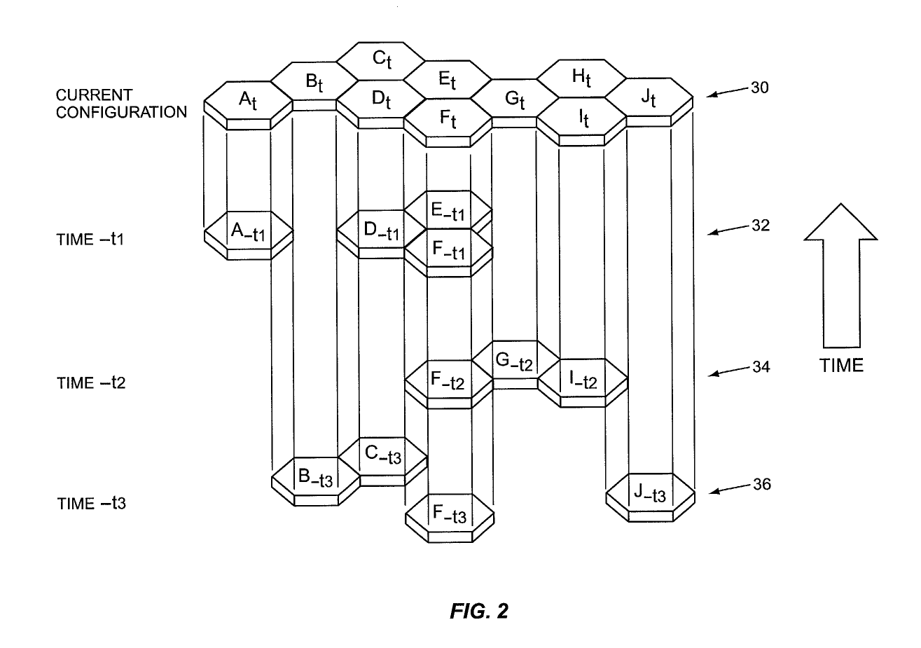

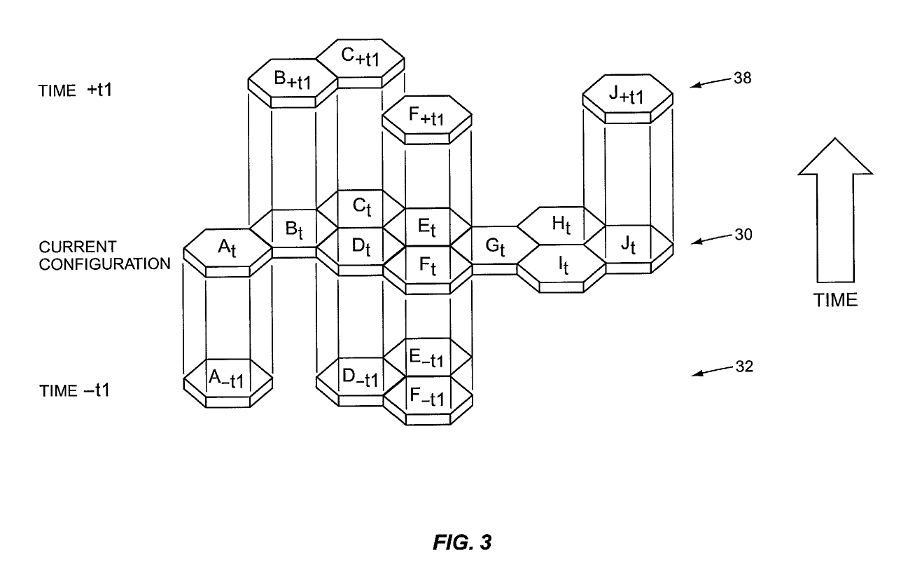

Because the number of managed objects in the MIB is usually quite large, and the number of changes is usually small in comparison, storing historical configuration data along with current configuration data does not significantly increase the size of the MIB. Because the changed objects in the MIB can be used to regenerate the configuration of the network or network element at any previous point in time (within the time limits of the stored data), the invention eliminates the need to make backup copies of the MIB at discrete points to use for restoration purposes. The present invention is described in more detail with particular reference to FIGS. 2 and 3.

As shown in FIG. 2, the current state of the MIB, indicated at 30, is fully maintained, and accurately reflects the current configuration or state of the communications network 10 at time t. The MIB 30 comprises a collection of managed objects and associated attributes that contain the configuration data at various points in time. The managed objects are indicated by letters A, B, etc. The subscript t indicates the current version of the managed objects. When the configuration data for any managed object is changed, a “snapshot” of the managed object as it exists prior to the change is captured and stored as a changed object. For example, the changed versions of managed objects A, D, E, and F, which were changed to the current state at time −t1, are represented as changed objects A₋ₜ₁, D₋ₜ₁, E₋ₜ₁, and F₋ₜ₁ as indicated by 32. Similarly, changed versions of managed objects F, G, and I, as they existed at time −t2, are represented as changed objects F₋ₜ₂, G₋ₜ₂, and I₋ₜ₂ as indicated by 34. In like manner, configuration data at time −t3 for changed versions of managed objects B, C, F, and J are represented as changed objects B₋ₜ₃, C₋ₜ₃, F₋ₜ₃, and _{J-t3} as indicated by 36.

Note that for a given managed object, such as for example managed object F in FIG. 2, the complete set of all changes to that managed object—F₋ₜ₁, F₋ₜ₂, and F₋ₜ₃—is maintained in the MIB 30 as a set of changed objects. Thus, it is a simple matter to regenerate the configuration of the network at any given point in time by simply “rolling back” changes to the managed objects to the desired point in time. That is, the MIB 30 may be “rolled back” to any of its previous states, i.e., its state at times −t1, −t2, and −t3, by restoring changed objects to form the previous configuration of the network at the time, e.g., −t1, −t2, or −t3, being recreated. By way of example, if it is desired to recreate the MIB 30 at time −t2 in FIG. 2, changed objects at times −t1 and −t2 would need to be restored. Note that in this example, the restoration of changed object F₋ₜ₂ would overwrite the restoration of changed object F₋ₜ₁ since it represents an earlier time. Thus, the present invention allows the MIB 30 to be restored its actual configuration at any time in the past.

Since all changed configuration data is carried forward as part of the MIB 30 in the form of changed objects, it is not necessary to make complete backups of the MIB 30 to use for subsequent restoration operations. Thus, network managers (who generally lack the ability to see into the future) need not choose between two evils—prolific backups in an attempt to save every state that may later turn out to be desired, or infrequent backups between which relevant states may be lost by compound changes. In fact, even in the former case, say, backups every night, prior art methods will not capture changes to a managed object made in the morning, that are superceded by changes to the same managed object made in the afternoon. According to the present invention, the state of the MIB 30 at noon, between the two changes, is fully recoverable.

A significant new functionality provided by the present invention is the ability to selectively restore the changed object—at any stage in its history—corresponding to one or more managed objects. This allows the creation of network configurations that did not previously exist, something that is not possible or is impractical using a conventional backup and restore paradigm. For example, the successive changes to the configuration data associated with managed object F in FIG. 2 may represent incremental improvements, each significantly increasing performance. In particular, the change from time −t1 to the current configuration of managed object F (i.e., state F₋ₜ₁ to Fₜ) may have necessitated complex adjustments to managed objects D and E, as indicated at 32 by the configuration data for all three managed objects having been altered in tandem at time −t1. A concurrent change to managed object A, on the other hand, may have been erroneous or ill-advised, or may have caused unanticipated incompatibilities with other managed objects, thus severely compromising the performance of the network. According to the present invention, the change to managed object A may easily be undone by restoring changed object A₋ₜ₁ in the MIB 30, without making any other changes. This “undoes” the detrimental change to managed object A, while preserving the investment in time and effort of carefully crafting the complimentary changes to managed objects D, E, and F.

Although the present invention is depicted in FIG. 2 as comprising chronologically oriented changes in configuration data, the present invention is not thus limited. The changed objects may in general include a variety of parameters (some of which may depend only on the changes, and not on the managed object itself), and may be organized and accessed in a variety of ways. For example, rather than a chronological analysis, it may be advantageous to undo all changes to managed objects initiated by a particular individual. As another example, if may be desirable to undo changes relating to a particular type or class of equipment. As yet another example, changes may be implemented to selected network resources to add both capacity and new functionality for a limited duration, such as for a city hosting a major sports event, convention, festival, or the like. Upon the termination of the event and the concomitant decreased need for the capacity, the changes may be selectively undone to restore the network to its prior configuration, but the functionality-increasing changes may be retained for future use. The ability to selectively undo changes enables a vast flexibility in troubleshooting a problematic or poorly performing network, since the entire network need not be “rolled back” to one or more backup dates, but rather individual changes to the network configuration may be selectively rolled back, greatly enhancing the ability to isolate and fix network configuration problems.

In addition to providing enhanced flexibility in rolling back a MIB 30 by undoing changes to managed objects, the present invention additionally provides the ability to analyze and simulate prospective or projected changes to managed objects. As depicted in FIG. 3, a managed object reflecting a current configuration may be replaced by a future or proposed managed object, indicated by 38, to simulate proposed changes to the network or network element. For example, a future object J, indicated as J₊ₜ₁, may be substituted for the current managed object Jₜ in the MIB 30, and various performance simulations performed to validate or quantify the effect of the change to managed object J. As another example, a change to managed object B may necessitate various corresponding changes to managed object C, due to interdependencies between the two. The changed configuration data B₊ₜ₁ and C₊ₜ₁ may be substituted for Bₜ and Cₜ, respectively, in the MIB 30, and their specific values fine-tuned as necessary, before implementing the changes. This capability provides the network administrator with a powerful “what if” tool, allowing proposed changes to the network to be analyzed and simulated for compatibility, performance, efficiency, and the like. In fact, the current managed objects may be replaced by a combination of one or more future objects 38 and one or more changed objects 32 providing even greater flexibility in ironing out incompatibilities and optimizing performance among the managed objects.

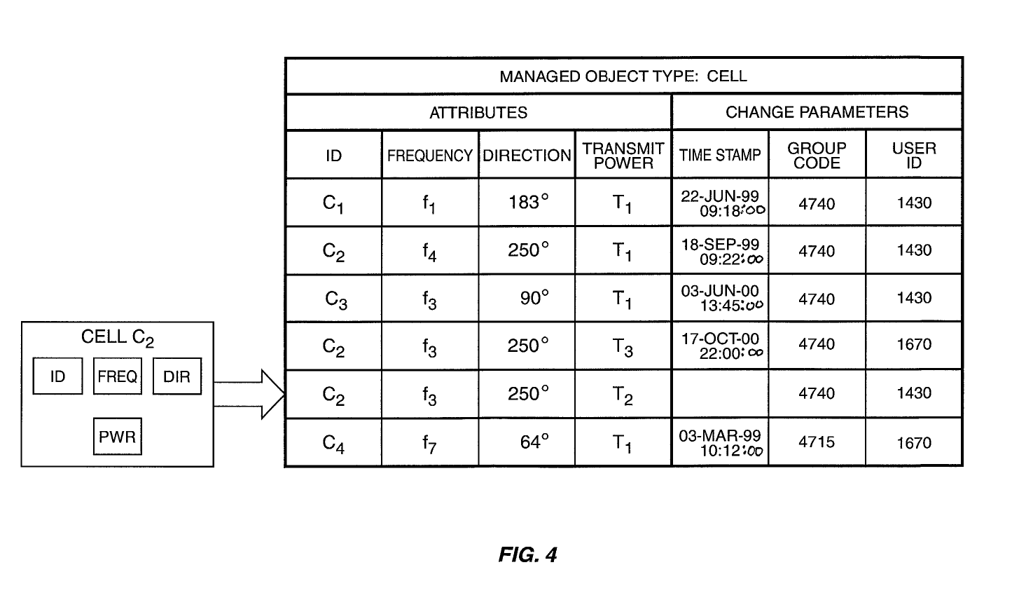

FIG. 4 illustrates an exemplary implementation of the MIB 30. FIG. 4 shows a schematic representation of a managed object, which in this example is a cell C₂ in the wireless communication network 10 of FIG. 1. The attributes of the cell-type managed object include an identifier (ID) that uniquely identifies the particular cell, the frequency, the direction, and the transmit power of the cell. FIG. 4 also illustrates a table for storing information about cell-type managed objects. The MIB 30 contains a separate table for each type of managed object, and each table may contain one or more managed objects of the appropriate type, as well as different version of attributes for a given managed object. Thus, all managed objects of the same type could be stored in the same table, although different tables could also be used for current versions and changed versions of the managed objects. In a preferred embodiment of the invention, changed versions of the managed objects, referred to herein as changed objects, are stored in the same table along with the currently valid versions of the managed objects. The currently valid version of each managed object may be indicated by a flag, by its position as the first row in the table, by the absence of a change timestamp; or by other means as may be apparent to those of skill in the art.

The structure of the table is dependant on the type of the managed object contained therein. In general, the rows of the table correspond to a particular managed object at a particular time. The table also includes columns corresponding to the various attributes of the managed objects (such as for example, ID, direction, frequency, transmit power, and the like). Other parameters relating to changes made to a managed object may also be stored in the table. For example, in addition to the inherent attributes of a managed object, the table may include columns corresponding to various change parameters that relate to changes to the managed objects. Change parameters may include, for example, a timestamp reflecting the date/time of a change to the managed object, the ID of the person making the change, the reason for the change, a flag to indicate a current version or a changed version of each managed object, a group code that is used to group managed objects together, or the like.

In the particular implementation shown in FIG. 4, the managed object table includes a timestamp column that is used to indicate the dates and times at which the managed objects were changed and to determine the current version of each managed object. The current version of a managed object is determined by the absence of a timestamp in the timestamp field. The timestamp may also be used to roll back changes to the MIB 30 to any point in time. The managed object table in FIG. 4 further includes a group code field, which contains a code that may be used to group changed versions of various managed objects together for restoration as a group.

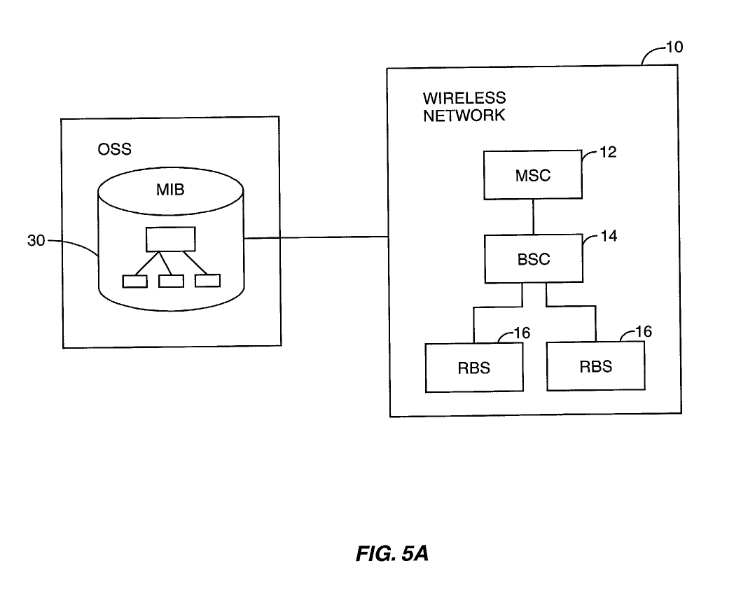

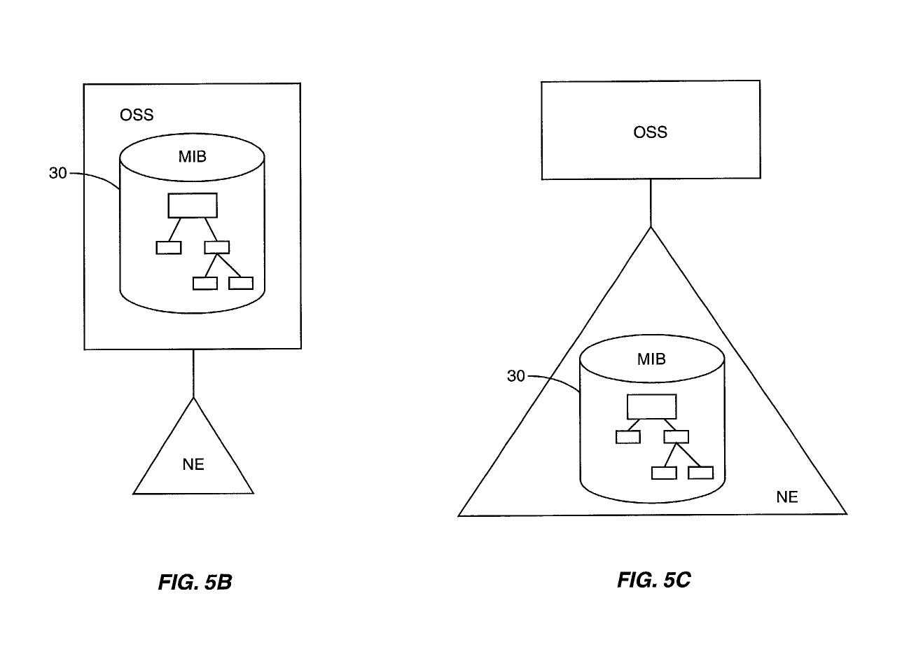

FIGS. 5A through 5C illustrate various locations where the MIB 30 may reside in the network 10. In FIG. 5A, the MIB 30 resides in a centralized operation support system (OSS) node within the network 10. In FIG. 5B, the MIB resides in an operation support system (OSS) that interfaces directly with the network element (NE), e.g., RBS 16 or BSC 14, being modeled. In this case, the MIB 30 may be distributed among a number of network nodes. In FIG. 5C, the MIB 30 resides within the network element itself so that each network element manages its own MIB 30. The location of the MIB 30 is not material to the present application, but is mentioned herein to place the invention in context.

Although the present invention has been described herein with respect to particular features, aspects and embodiments the numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of maintaining network configuration data in a database, said method comprising:
storing current configuration data representing a current configuration of said network in a database as a collection of managed objects, wherein each managed object has attributes corresponding to variables that can be configured to manage and control operation of the network; and
storing historical configuration data representing past configurations of said network in said database as a collection of changed objects, wherein each changed object represents a past configuration of one of said managed objects that has been changed.

2. The method of claim 1, further comprising restoring said database to a prior version by restoring historical configuration data from at least one changed object.

3. The method of claim 1 further comprising altering said database by selectively restoring historical configuration data from one or more changed objects.

4. The method of claim 1 further comprising storing, contemporaneously with storing said historical configuration data, change parameters associated with the change.

5. The method of claim 5 wherein said change parameters include a timestamp.

6. The method of claim 6, wherein said historical configuration data to be substituted into said database is selected based on said timestamp.

7. The method of claim 5 wherein said change parameters include an operator identification.

8. The method of claim 8, wherein said historical configuration data to be substituted into said database is selected based on said operator identification.

9. The method of claim 5 wherein said change parameters include a group code.

10. The method of claim 10, wherein said historical configuration data to be substituted into said database is selected based on said group code.

11. A database stored in a memory for maintaining configuration data associated with one or more managed objects in a communication network, said database comprising:
current configuration data representing current values for configurable attributes of the managed objects; and
historical configuration data comprising one or more changed objects, wherein each changed objects represents a past configuration of one of said managed objects that has been changed.

12. The database of claim 11, wherein said historical configuration data further includes change parameters associated with the change.

13. The database of claim 11, wherein said database is restored to a prior version by restoring historical configuration data associated with at least one changed object.

14. The database of claim 11, wherein said database is altered by selectively restoring historical configuration data associated with one or more changed objects.

15. The database of claim 12 further comprising prospective configuration data stored as one or more changed objects representing proposed changes to one or more managed objects.

16. The database of claim 15, wherein said database is altered by selectively substituting prospective configuration data associated with one or more said changed objects for the associated current configuration data.

17. The database of claim 15, wherein said database includes both said historical configuration data and said prospective configuration data.

18. The database of claim 17, wherein said database is altered by selectively substituting prospective configuration data associated with one or more said changed objects for the associated current configuration data, and selectively substituting historical configuration data associated with one or more other of said changed objects for the associated current configuration data.

19. A database stored in a memory for maintaining configuration data associated with one or more managed objects in a communication network, said database comprising:
one or more changed objects storing historical configuration data;
wherein each changed object represents a past configuration of a managed objects that has been changed; and
wherein each changed object includes at least one change parameter relating to a change in the corresponding managed object.

20. The database of claim 20, wherein said change parameter is a timestamp representing the time of a corresponding change to the managed object.

21. The database of claim 20, wherein said change parameter is a user identification of a user that made a corresponding change to the managed object.

22. The database of claim 20, wherein said change parameter is a group code.

23. A communication network comprising:
a network entity comprising one or more managed objects, each managed object having one or more configurable attributes that can be configured by a user;
a database for storing the current configuration of the managed objects; and
one or more changed objects stored in said database, wherein each changed objects represents a past configuration of one of said managed objects that has been changed.

24. The communication network of claim 23, wherein said historical configuration data further includes change parameters associated with a change in a managed object.

25. The communication network of claim 23, wherein said database is restored to a prior version by restoring historical configuration data associated with at least one changed object.

26. The communication network of claim 23, wherein said database is altered by selectively restoring historical configuration data associated with one or more changed objects.

27. The communication network of claim 23 further comprising prospective configuration data stored in said database as a one or more changed objects, said prospective configuration data reflecting proposed changes to the associated managed object.

28. The communication network of claim 26, wherein said database is altered by selectively substituting prospective configuration data associated with one or more said changed objects for the associated current configuration data.

29. The communication network of claim 27, wherein said database includes both said historical configuration data and said prospective configuration data.

30. The communication network of claim 29, wherein said database is altered by selectively substituting prospective configuration data associated with one or more said changed objects for the associated current configuration data, and selectively substituting historical configuration data associated with one or more other of said changed objects for the associated current configuration data.
